(19) United States
(12) Patent Application Publication
(10) Pub. No.: US 2007/0121737 A1
(43) Pub. Date: May 31, 2007

(54) Transmission apparatus and peak suppression method

(75) Inventors: Isamu Yoshii, Urayasu-shi (JP); Kenichi Miyoshi, Yokohama-shi (JP); Jun Cheng, Soraku-gun (JP); Akihiko Nishio, Yokosuka-shi (JP); Masaru Fukuoka, Kanazawa-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD, OSAKA (JP)

(21) Appl. No.: 10/573,687

(22) PCT Filed: Sep. 27, 2004
(86) PCT No.: PCT/JP04/14057

§ 371 Date: Mar. 27, 2006

(30) Foreign Application Priority Data
Sep. 30, 2003 (JP) 2003-341684

(51) Int. Cl. H04K 1/10

(52) U.S. Cl. 375/260

(57) ABSTRACT

A transmission apparatus capable of improving overall throughput of a system by suppressing peaks using some frequencies in a communication band. In this apparatus, modulation section (102) adaptively modulates transmission data. Combination section (103) combines the waveform of the transmission data and an inverse replica and suppresses peaks equal to or higher than a threshold. When there are peaks equal to or higher than a threshold, inverse replica generation section (112) extracts the waveform of a peak equal to or higher than the threshold and generates an inverse replica which is the waveform having the inverse characteristic of the extracted waveform. Sub-band selection section (114) selects frequencies of subcarriers for which MCS having low transmission efficiency is selected and outputs the inverse replica within the range of the selected frequency to combination section (103).

### TECHNICAL FIELD

The present invention relates to a transmission apparatus and a peak suppression method, and more specifically, to a transmission apparatus and a peak suppression method where transmission signals are transmitted by an OFDM scheme.

### BACKGROUND ART

Conventionally, a multicarrier communication apparatus employing an OFDM scheme is resistant to multipath and fading and realizes high quality communication, and therefore multicarrier communication apparatuses employing the OFDM scheme are attracting attention as the apparatus capable of realizing high-speed radio transmission. In OFDM scheme communication, transmission data is converted to parallel data and transmitted by being superimposed on a plurality of subcarriers, and therefore there is no correlation between subcarriers. For this reason, when the phases of subcarriers overlap one another, OFDM symbols have extremely large signal amplitudes. When the peak voltage of a signal increases in transmission due to the overlap of the phases of in this way, an amplifier with a dynamic range including peak electric power is required to amplify the transmission signal, which increases the size of the amplifier and also increases power consumption. Furthermore, an increase in peak power of a signal during transmission requires an amplifier capable of keeping linearity over an extensive area, hence an expensive amplifier.

Therefore, a method of suppressing peak power through processing of placing restrictions on the amplitude to reduce the amplitude of the overall transmission signal using a limiter (for example, Patent Document 1) and a method of suppressing peak voltages through processing called “clipping” to suppress only peaks are conventionally known.

When suppressing such peaks, a transmission apparatus that includes peak-suppressed information in data and transmits the information is known. A reception apparatus which receives data transmitted from such a transmission apparatus reconstructs the suppressed peaks using the peak-suppressed information, and can thereby decode the data without errors.

On the other hand, OFDM scheme communication employs a system in which a base station apparatus is reported reception quality at a communication terminal apparatus from the communication terminal apparatus on a per subcarrier basis, assigns a number of multiple subcarriers which are appropriate for each user based on the reported reception quality (frequency division user multiplexing) and selects MCS (Modulation and Coding Schemes) for each subcarrier. That is, the base station apparatus assigns each communication terminal a subcarrier having highest frequency utilization efficiency that can satisfy desired communication quality (e.g., a minimum transmission rate, error rate, etc.), selects high-speed MCS for each subcarrier, carries out data transmission and thereby realizes high-speed data communication for multi-users.
Patent Document 1: Unexamined Japanese Patent Publication No. HEI9-18451

### DISCLOSURE OF INVENTION

Problems to be Solved by the Invention

However, the conventional transmission apparatus and peak suppression method include information about peak suppression in transmission data without considering the MCS of each subcarrier, and this results in a problem that, when high-MCS carrier components are suppressed, overall throughput of the system deteriorates considerably.

It is therefore an object of the present invention to improve overall throughput of the system through peak suppression using some frequencies in a communication band.

Means for Solving the Problem

The transmission apparatus of the present invention transmits a frequency division multiplexed transmission signal based on reception quality information indicating reception quality of a communicating party, and this transmission apparatus employs a configuration having: a determining section that determines a modulation and coding scheme parameter per frequency; a detection section that detects a peak of a transmission signal; a generation section that generates a waveform with an inverse characteristic of a waveform of the peak; a combination section that combines the waveform of the transmission signal and the waveform with the inverse characteristic at a frequency corresponding to the modulation and coding scheme parameter of a lowest transmission efficiency among the modulation and coding scheme parameters determined for respective frequencies; and a transmission section that transmits the transmission signal combined with the waveform with the inverse characteristic.

The peak suppression method of the present invention suppresses a peak in a frequency division multiplexed transmission signal based on reception quality information indicating reception quality of a communicating party, and this peak suppression method includes the steps of: determining a modulation and coding scheme parameter per frequency; detecting a peak of a transmission signal; generating a waveform with an inverse characteristic of a waveform of the peak; and combining the waveform of the transmission signal and the waveform with the inverse characteristic at a frequency corresponding to the modulation and coding scheme parameter of a lowest transmission efficiency among the modulation and coding scheme parameters determined for respective frequencies.

Advantageous Effect of the Invention

According to the present invention, it is possible to improve overall throughput of a system through peak suppression by suppressing peaks using some frequencies in a communication band.

### BRIEF DESCRIPTION OF DRAWINGS

FIG. 1 is a block diagram showing the configuration of a radio communication apparatus according to Embodiment 1 of the present invention;

FIG. 2 illustrates an MCS table according to Embodiment 1 of the present invention;

FIG. 3 is a flow chart showing the operation of the radio communication apparatus according to Embodiment 1 of the present invention;

FIG. 4 is a diagram illustrating a relationship between time and PAPR in the waveform of a transmission signal according to Embodiment 1 of the present invention;

FIG. 5 is a diagram illustrating a relationship between the time and amplitude in the waveform of a transmission signal according to Embodiment 1 of the present invention;

FIG. 6 is a diagram illustrating a relationship between the time and amplitude of a replica according to Embodiment 1 of the present invention;

FIG. 7 is a diagram illustrating a relationship between the time and amplitude of an inverse replica according to Embodiment 1 of the present invention;

FIG. 8 is a diagram illustrating subcarriers according to Embodiment 1 of the present invention;

FIG. 9 is a diagram illustrating a waveform after FFT of the inverse replica according to Embodiment 1 of the present invention;

FIG. 10 is a diagram illustrating a histogram of PAPR of a transmission signal according to Embodiment 1 of the present invention;

FIG. 11 is a diagram illustrating a relationship between Eb/Nₒ and BER of a transmission signal according to Embodiment 1 of the present invention;

FIG. 12 is a flow chart showing the operation of a radio communication apparatus according to Embodiment 2 of the present invention;

FIG. 13 is a diagram illustrating subcarriers according to Embodiment 2 of the present invention;

FIG. 14 is a flow chart showing the operation of a radio communication apparatus according to Embodiment 3 of the present invention;

FIG. 15 is a flow chart showing the operation of the radio communication apparatus according to Embodiment 3 of the present invention;

FIG. 16 is a block diagram showing the configuration of a radio communication apparatus according to Embodiment 4 of the present invention;

FIG. 17 is a block diagram showing the configuration of a radio communication apparatus according to Embodiment 5 of the present invention; and

FIG. 18 is a flow chart showing the operation of the radio communication apparatus according to Embodiment 5 of the present invention.

### BEST MODE FOR CARRYING OUT THE INVENTION

Now, embodiments of the present invention will be described in detail with reference to the accompanying drawings.

### Embodiment 1

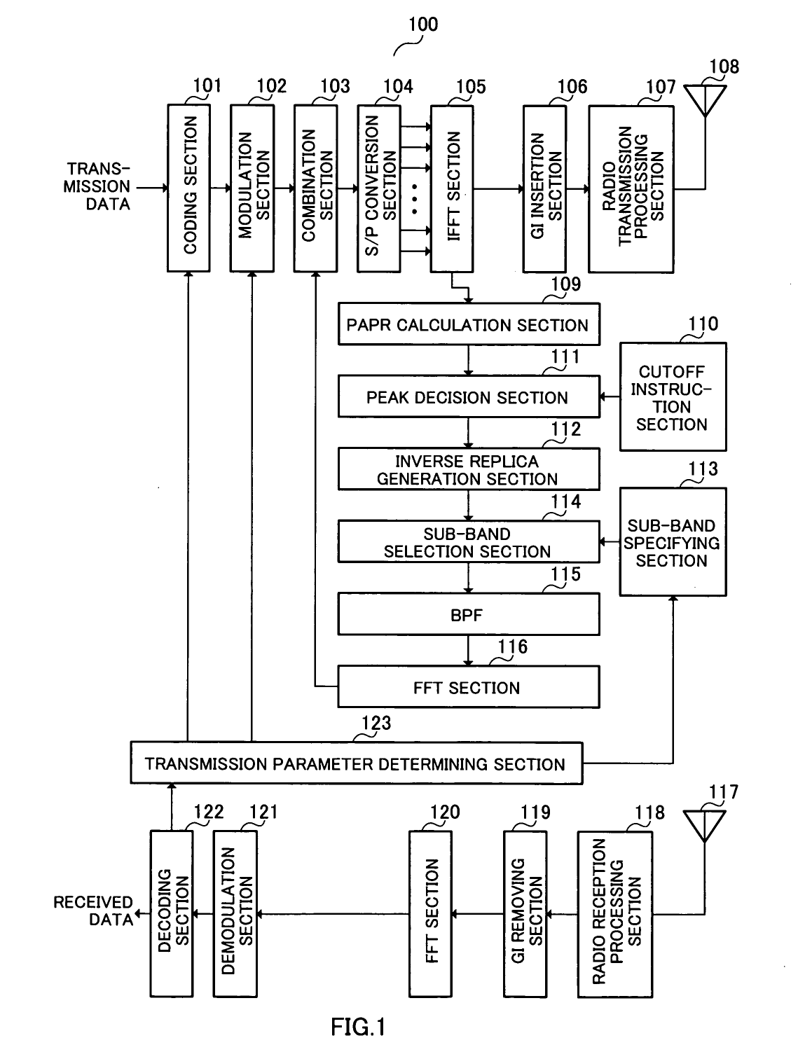

FIG. 1 is a block diagram showing the configuration of radio communication apparatus 100 according to Embodiment 1 of the present invention.

Coding section 101 codes transmission data at a coding rate from coding rate information input from transmission parameter determining section 123 and outputs the coded transmission data to modulation section 102.

Modulation section 102 modulates transmission data input from coding section 101 according to a modulation scheme based on modulation scheme information input from transmission parameter determining section 123 and outputs the modulated transmission data to combination section 103.

Based on inverse replica information, which is information about the waveform with an inverse characteristic of the waveform equal to or higher than a threshold input from FFT section 116 (hereinafter “inverse replica”), combination section 103 combines the waveform of the transmission data input from modulation section 102 and the inverse replica on the frequency axis, and outputs the combined signal to serial/parallel (hereinafter “S/P”) conversion section 104.

S/P conversion section 104 converts the transmission data input from combination section 103 from a serial data format to a parallel data format and outputs the parallel data to inverse Fourier transform (hereinafter “IFFT”) section 105.

IFFT section 105 is an inverse orthogonal transform section, performs IFFT on the transmission data input from S/P conversion section 104, and outputs the transformed data to guard interval (hereinafter “GI”) insertion section 106 and peak-to-average power ratio (hereinafter “PAPR”) calculation section 109.

GI insertion section 106 inserts a GI in the transmission data input from IFFT section 105 and outputs the transmission data to radio transmission processing section 107.

Radio transmission processing section 107 up-converts the transmission data input from GI insertion section 106 from a baseband frequency to a radio frequency and transmits the result from antenna 108.

PAPR calculation section 109 calculates PAPR from the transmission data after IFFT input from IFFT section 105 and outputs the calculation result to peak decision section 111.

Cutoff instruction section 110 outputs PAPR information, which is threshold information to delete the amplitude of the transmission data, to peak decision section 111.

Peak decision section 111 is a peak detection section, compares the PAPR calculation result input from PAPR calculation section 109 with threshold information input from cutoff instruction section 110 and decides whether or not there are peaks indicating PAPR equal to or higher than the threshold. Then, when there are peaks indicating PAPR equal to or higher than the threshold, peak decision section 111 outputs the waveform information of the transmission data including peaks equal to or higher than the threshold, to inverse replica generation section 112.

Inverse replica generation section 112 is a waveform generation section, generates a waveform to cancel the waveform information input—that is, an inverse replica—from the waveform information input from peak decision section 111, and outputs inverse replica information to sub-band selection section 114.

Sub-band specifying section 113 instructs sub-band selection section 114 to select the frequency band of a sub-band composed of a subcarrier, to which transmission data with the lowest transmission efficiency is assigned, in a communication band from the MCS information, which is information about the MCS (MCS parameter) input from transmission parameter determining section 123.

Sub-band selection section 114 selects a sub-band specified from sub-band specifying section 113, and outputs only the inverse replica input from inverse replica generation section 112 in the selected sub-band frequency band, to bandpass filter (hereinafter “BPF”) 115.

BPF 115 removes unnecessary band components outside the frequency band of the sub-band specified by sub-band specifying section 113 of the inverse replica from the inverse replica which is a canceling waveform generated by inverse replica generation section 112 from the inverse replica information input from sub-band selection section 114 and outputs the result to fast Fourier transform (hereinafter “FFT”) section 116.

FFT section 116 is an orthogonal transform section, performs FFT on the inverse replica based on the inverse replica information input from sub-band selection section 114 and outputs the inverse replica to combination section 103.

Radio reception processing section 118 down-converts a signal received by antenna 117 from a radio frequency to a baseband frequency and outputs the received signal to GI removing section 119.

GI removing section 119 removes the GI from the received signal input from radio reception processing section 118 and outputs the signal to FFT section 120.

FFT section 120 performs FFT on the received signal input from GI removing section 119 and outputs the result to demodulation section 121.

Demodulation section 121 demodulates the received signal input from FFT section 120 and outputs the result to decoding section 122.

Decoding section 122 decodes the received signal input from demodulation section 121 and outputs the decoded signal to transmission parameter determining section 123 and at the same time obtains received data.

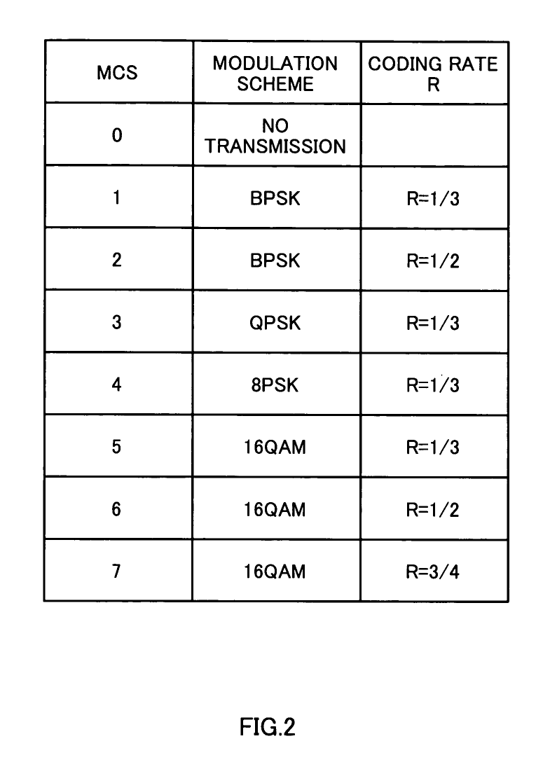

Transmission parameter determining section 123 selects MCS which indicates a combination of a modulation scheme and coding rate, using CQI (Channel Quality Indicator) which is reception quality information showing the reception quality of the communication terminal apparatus for each subcarrier and reception power information or the like, from the received data input from decoding section 122. That is, as shown in FIG. 2, transmission parameter determining section 123 includes an MCS table in which MCS, modulation schemes and coding rates are associated, and selects MCS, for each subcarrier, with reference to the MCS table with the CQI and reception power reported from the communication terminal apparatus taken into consideration. Transmission parameter determining section 123 then outputs the selected MCS of each subcarrier to sub-band specifying section 113 as MCS information. Furthermore, transmission parameter determining section 123 outputs the modulation scheme information which indicates the modulation scheme of selected MCS to modulation section 102 and outputs coding rate information which indicates the coding rate of the selected MCS to coding section 101. In FIG. 2, the transmission efficiency of the MCS increases in order from 0 to 7 and MCS7 indicates the highest transmission efficiency.

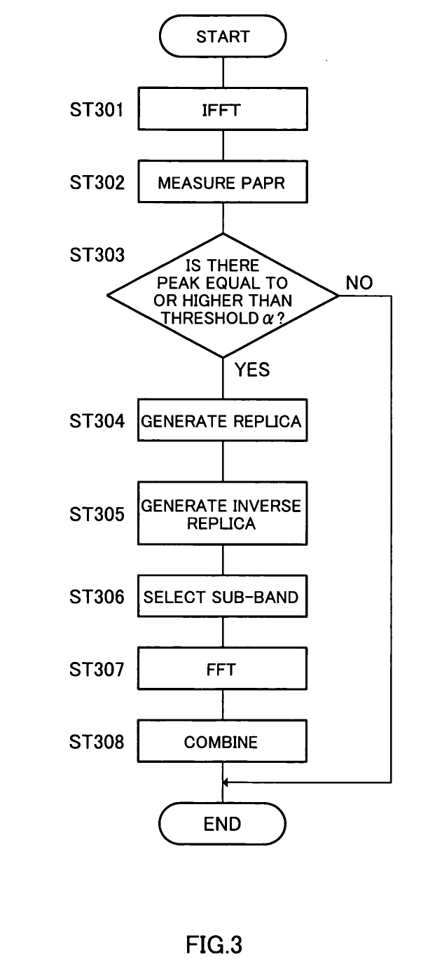

Next, peak suppression operation by radio communication apparatus 100 will be explained using FIG. 3 to FIG. 11. FIG. 3 is a flow chart showing peak suppression operation by radio communication apparatus 100.

First, IFFT section 105 performs IFFT on transmission data (step ST301).

Next, PAPR calculation section 109 measures PAPR (step ST302).

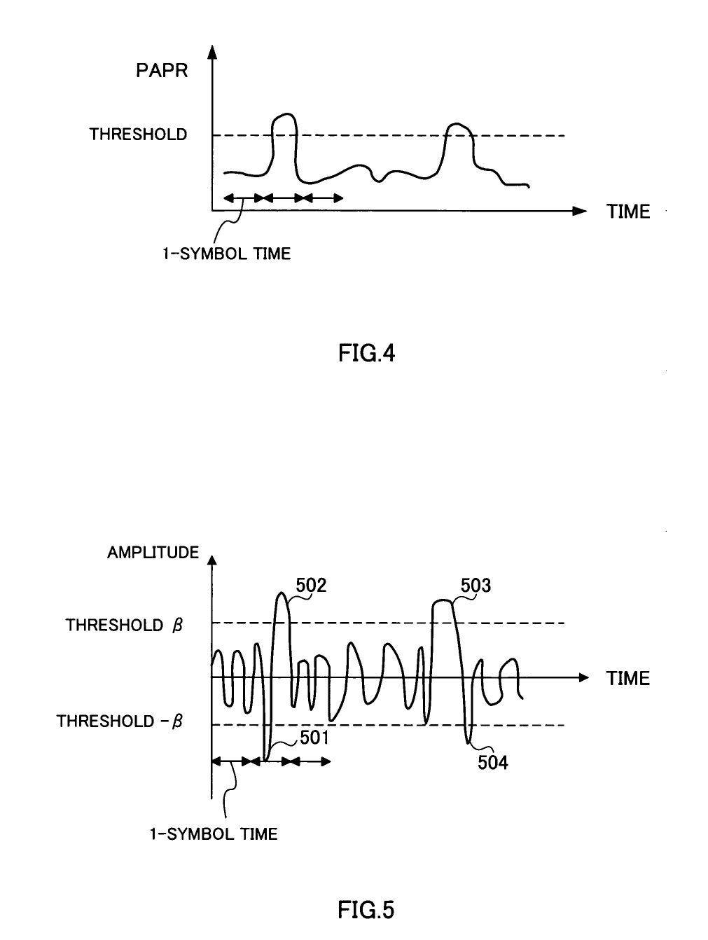

Next, as shown in FIG. 4, peak decision section 111 decides whether or not there is a peak whose PAPR is equal to or higher than threshold (α) from the threshold information input from cutoff instruction section 110 for each symbol (step ST303).

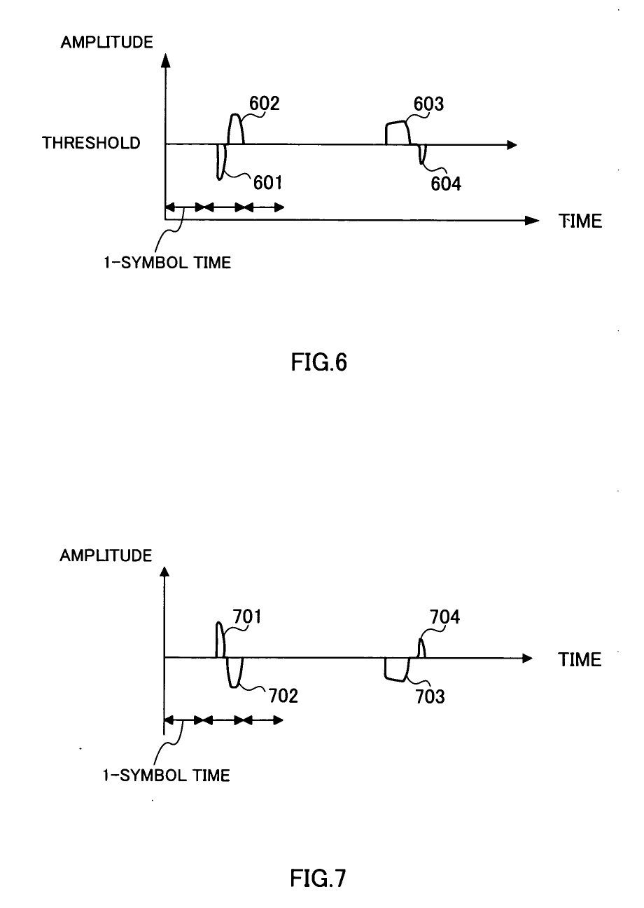

When there is a peak whose PAPR is equal to or higher than a threshold α, as shown in FIG. 5, inverse replica generation section 112 extracts waveform information 501, 502, 503, 504 whose amplitude is equal to or higher than threshold (β) and whose amplitude is equal to or lower than threshold (−β) in the relationship between time and amplitude of the transmission signal and generates replica 601 of waveform information 501, replica 602 of waveform information 502, replica 603 of waveform information 503 and replica 604 of waveform information 504 as shown in FIG. 6 (step ST304).

Next, inverse replica generation section 112 generates inverse replica 701 which has the inverse characteristic of replica 601, inverse replica 702 which has the inverse characteristic of replica 602, inverse replica 703 which has the inverse characteristic of replica 603 and inverse replica 704 which has the inverse characteristic of replica 604 as shown in FIG.7 (step ST305).

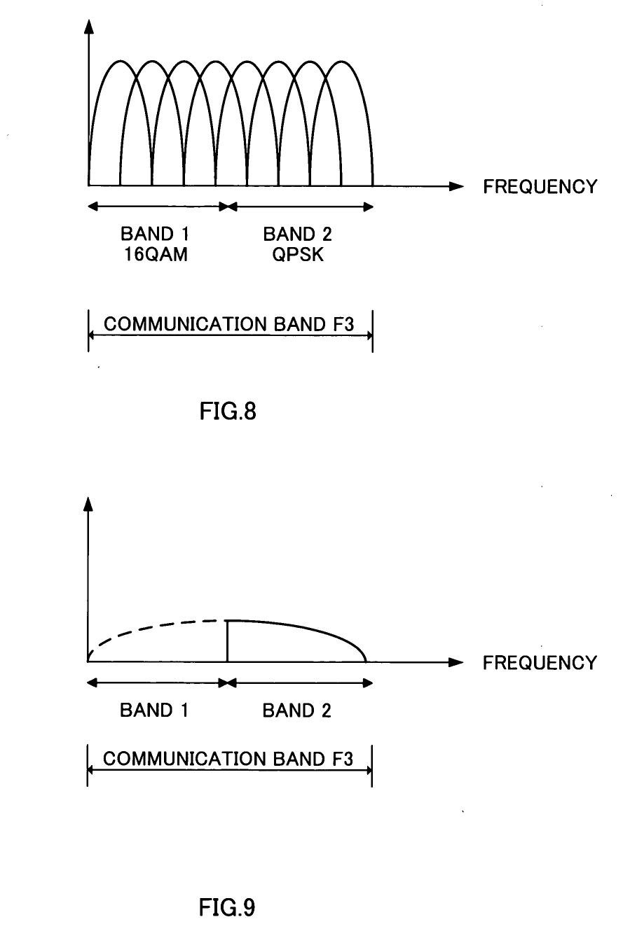

Next, sub-band selection section 114 selects the sub-band specified by sub-band specifying section 113 (step ST306) and BPF 115 outputs only an inverse replica in the frequency band of the sub-band specified by sub-band specifying section 113. More specifically, when MCS6 is selected in FIG. 2 for the transmission data assigned to subcarriers in band 1 (sub-band) and the transmission data is modulated by 16 QAM, and when MCS3 is selected for the transmission data assigned to subcarriers in band 2 (sub-band) and the transmission data is modulated by QPSK, sub-band selection section 114 selects band 2 whose MCS is low in communication band F3 as shown in FIG. 8.

Next, FFT section 116 performs FFT on the inverse replica of selected band 2 (step ST307). By performing FFT on the inverse replica of band 2, the waveform shown in FIG. 9 is obtained. The inverse replica of band 1 other than band 2 is not output from sub-band selection section 114, and therefore the waveform after FFT becomes only the solid line part in FIG. 9.

Next, combination section 103 combines the transmission signal and the inverse replica (the waveform of the solid line part in FIG. 9) of band 2 subjected to FFT (step ST308). In this way, by combining the inverse replica and transmission data in band 2, the possibility of errors that may occur in the transmission data assigned to the subcarriers of band 2 increases. However, when the inverse replica and transmission data are combined in band 2, less deterioration occurs in the error characteristic of the whole transmission data, because the inverse replica and transmission data are not combined in band 1, as opposed to the case where the inverse replica and transmission data are combined over the whole of communication band F3. Furthermore, even when errors occur in the transmission data of band 2, carrying out processing such as retransmission allows the transmission data of band 2 to be decoded without errors. On the other hand, in step ST303, when the PAPR is not higher than threshold (α), the inverse replica is not combined with the transmission signal.

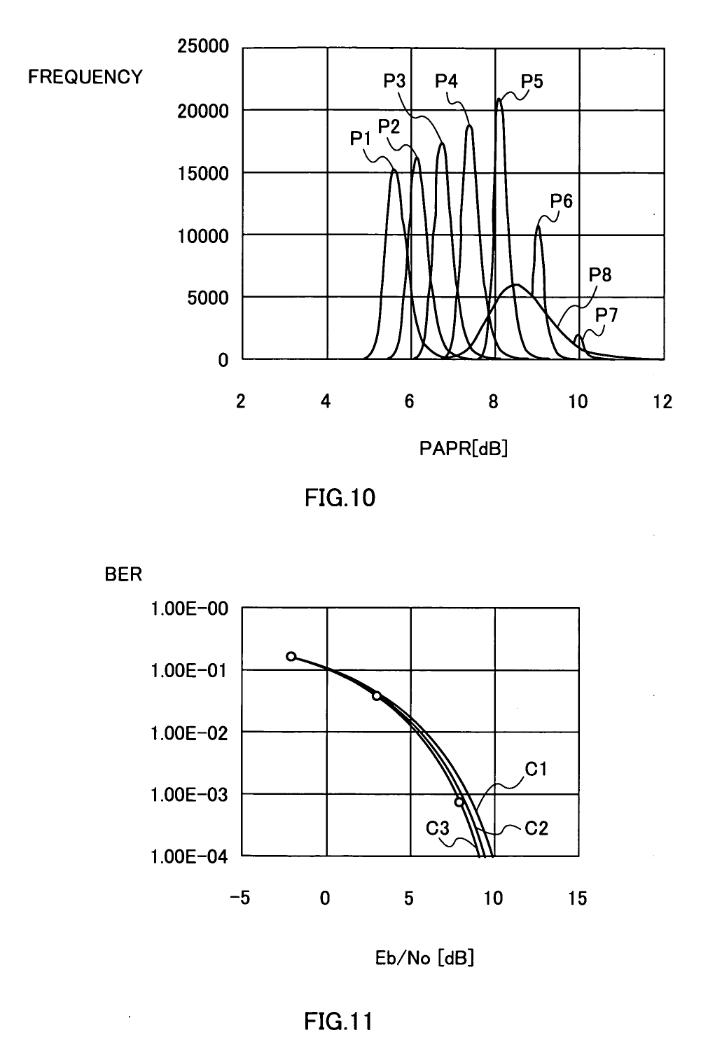

FIG. 10 and FIG. 1 show the result of a simulation. FIG. 10 shows a histogram of PAPR when peak suppression processing (clipping) is performed all over the conventional bands and FIG. 11 shows a relationship between the power to noise ratio (Eb/No) per bit and BER when the conventional peak suppression threshold is made variable.

In FIG. 10, P1 shows a histogram of PAPR when peak suppression is performed with a threshold set to 4 dB; P2 shows a histogram of PAPR when peak suppression is performed with a threshold set to 5 dB; P3 shows a histogram of PAPR when peak suppression is performed with a threshold set to 6 dB; P4 shows a histogram of PAPR when peak suppression is performed with a threshold set to 7 dB; P5 shows a histogram of PAPR when peak suppression is performed with a threshold set to 8 dB; P6 shows a histogram of PAPR when peak suppression is performed with a threshold set to 9 dB; P7 shows a histogram of PAPR when peak suppression is performed with a threshold set to 10 dB; and P8 shows a histogram of PAPR when no peak suppression is performed. From FIG. 10, it is appreciated that peak suppression eliminates PAPRs greater than thresholds. However, the elimination of peak components causes deterioration in BER, as shown in FIG. 11.

In FIG. 11, C1 shows the relationship between BER and Eb/Nₒ where a threshold is set to 4 dB, C2 shows the relationship between BER and Eb/No where a threshold is set to 5 dB; and C3 shows the relationship between BER and Eb/No where a threshold is set to 8 dB. From FIG. 11, it is appreciated that the error rate becomes smaller when a threshold is set to 5 dB than when a threshold is set to 4 dB and the error rate becomes smaller when a threshold is set to 8 dB than when a threshold is set to 5 dB. From FIG. 10 and FIG. 11, it is appreciated that PAPR can be lowered by reducing the threshold, but BER deteriorates.

Thus, according to this embodiment 1, it is possible to assign deterioration factors due to peak suppression to subcarriers of MCS of low transmission efficiency, so that overall throughput of the system can be improved.

### Embodiment 2

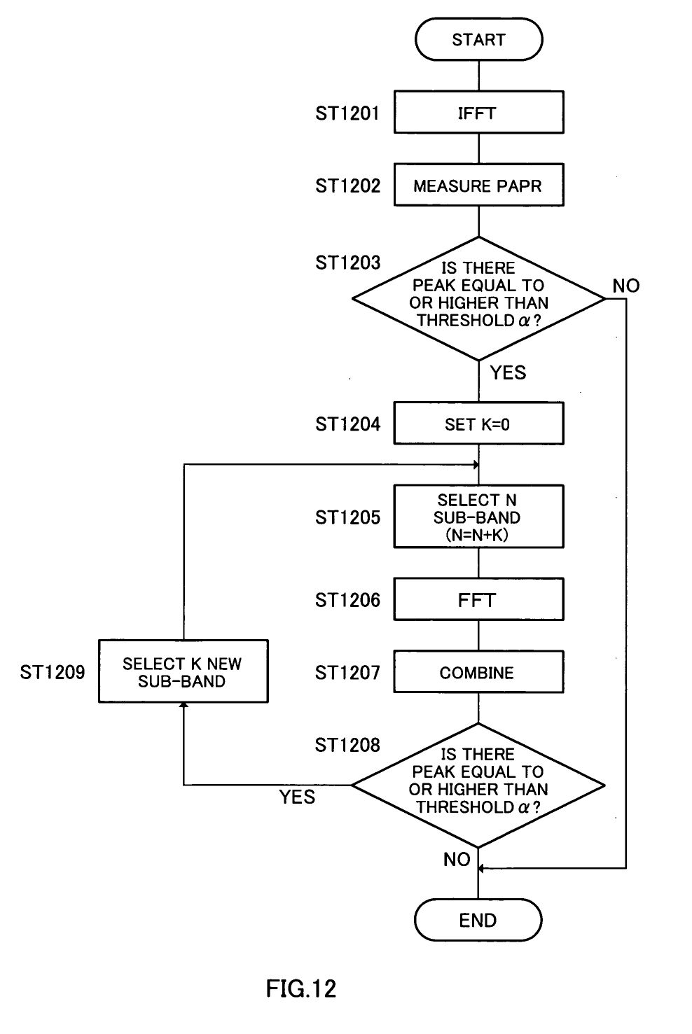

FIG. 12 is a flow chart showing operation of a wireless communication apparatus when suppressing peaks. The radio communication apparatus according to this embodiment 2 has the same configuration as that in FIG. 1, and therefore explanations thereof will be omitted.

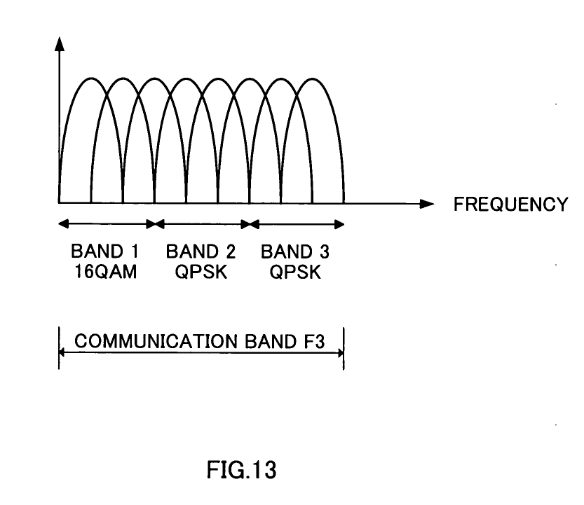

Peak suppression operation by the radio communication apparatus will be explained using FIG. 12 and FIG. 13.

First, IFFT section 105 performs IFFT on transmission data (step ST1201).

Next, PAPR calculation section 109 measures PAPR (step ST1202).

Next, as shown in FIG. 4, peak decision section 111 decides whether or not there is a peak whose PAPR is equal to or higher than threshold (α) from threshold information input from cutoff instruction section 110 (step ST1203).

When there is a peak whose PAPR is equal to or higher than threshold α, sub-band selection section 114 sets K=0 (step ST1204).

Next, sub-band selection section 114 selects N (N: natural number, equal to or smaller than the total number of sub-bands in the communication band) sub-bands specified by sub-band specifying section 113 (step ST1205) and outputs only inverse replicas in the frequency band of the selected N sub-bands. For example, in the case where MCS6 is selected for transmission data assigned to subcarriers of band (sub-band) 1 and the transmission data is modulated by 16 QAM, MCS3 is selected for transmission data assigned to subcarriers of band (sub-band) 2 and the transmission data is modulated by QPSK, and MCS3 is selected for transmission data assigned to subcarriers of band 3 (sub-band) and the transmission data is modulated by QPSK, sub-band selection section 114 selects band 2 for which MCS with low transmission efficiency is selected.

Next, FFT section 116 performs FFT on an inverse replica in the frequency band of selected band 2 (step ST1206). The waveform shown in FIG. 9 can be obtained by applying FFT to the inverse replica in band 2. Inverse replicas outside the frequency band of band 2 are not output from sub-band selection section 114, and therefore the waveform after FFT is only the solid line part in FIG. 9.

Next, combination section 103 combines the transmission signal and the inverse replica subjected to FFT (the waveform corresponding to the solid line part in FIG. 9) (step ST1207).

Next, peak decision section 111 again decides whether or not there is a peak equal to or higher than threshold α in the transmission data subjected to IFFT after the inverse replica is combined (step ST1208).

When there is a peak equal to or higher than threshold α in the transmission data, sub-band selection section 114 newly selects K new sub-bands (step ST1209) More specifically, as shown in FIG. 13, sub-band selection section 114 selects band 3 for which MCS with the same transmission efficiency as the MCS of band 2 is selected as the new sub-band. When there is no band for which MCS with the same transmission efficiency as the MCS of band 2 is set, sub-band selection section 115 selects a band for which MCS with the next lowest transmission efficiency to band 2 is selected.

Then, the radio communication apparatus repeats the processing of steps ST1205 to ST1208 until there are no more peaks equal to or higher than threshold α. That is to say, until there are no peaks equal to higher than threshold α, the radio communication apparatus repeats the processing of steps ST1205 to ST1209 until all bands in the communication band are selected (until a maximum of N is reached).

In step ST1208, when there is no peak equal to or higher than threshold α, the radio communication apparatus concludes peak suppression processing.

In step ST1203, when there is no peak equal to or higher than threshold α, the radio communication apparatus concludes peak suppression processing.

In this way, in addition to the effect of above Embodiment 1, this Embodiment 2 sequentially selects new bands and expands the band in which inverse replicas are combined until there are no more peaks equal to or higher than threshold α, so that error rate characteristic of the transmission data of one band can be prevented from deteriorating.

### Embodiment 3

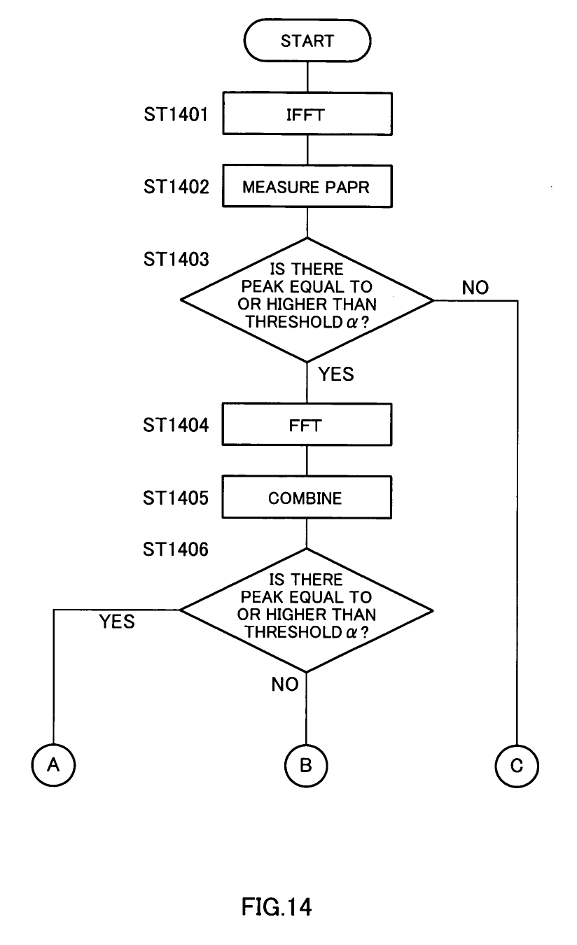

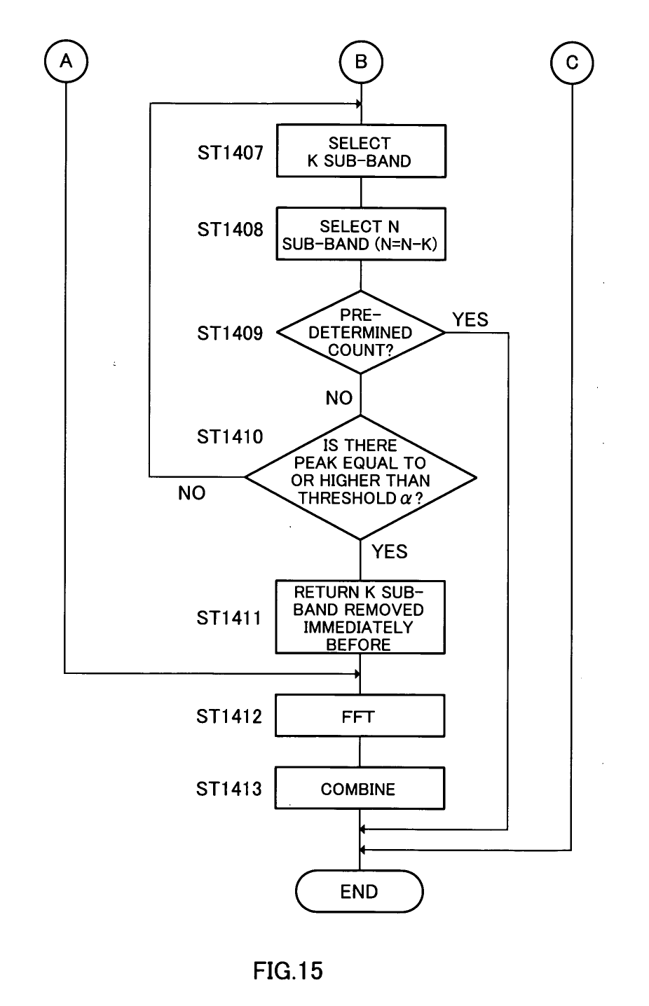

FIG. 14 and FIG. 15 are flow charts showing peak suppression operation by a radio communication apparatus. The radio communication apparatus according to this embodiment 3 has the configuration similar to that in FIG. 1, and therefore explanations thereof will be omitted.

Peak suppression operation by the radio communication apparatus will be explained using FIG. 14.

First, IFFT section 105 performs IFFT on transmission data (step ST1401).

Next, PAPR calculation section 109 measures PAPR (step ST1402).

Next, peak decision section 111 decides whether or not there is a peak whose PAPR is equal to or higher than threshold (α) from threshold information input from cutoff instruction section 110 as shown in FIG. 4 (step ST1403).

When PAPR is equal to or higher than threshold α, FFT section 116 performs FFT on an inverse replica (step ST1404).

Next, combination section 103 combines the transmission signal and the inverse replica in a predetermined communication band (step ST1405).

Next, peak decision section 111 again decides whether or not there is a peak equal to or higher than threshold α in the transmission signal after the combination of the inverse replica and transmission signal (step ST1406).

When there is no peak equal to or higher than threshold α, sub-band selection section 114 selects K sub-bands for which the MCS having the highest transmission efficiency is selected (step ST1407). More specifically, as shown in FIG. 13, sub-band selection section 114 selects one band 1 for which the MCS having the highest transmission efficiency is selected in the communication band.

Next, sub-band selection section 114 removes band 1 from all of bands 1 to 3 in the communication band and selects remaining band 2 and band 3 (step ST1408).

Next, sub-band selection section 114 counts one every time performing the sub-band selection processing and decides whether or not the total count has reached a predetermined count (step ST1409).

When the total count has not reached the predetermined count, sub-band selection section 114 decides whether or not a peak is detected by peak decision section 111 (step ST1410).

When no peak is detected by peak decision section 111, sub-band selection section 114 again selects K sub-bands for which MCS having the highest transmission efficiency is selected from the remaining sub-bands selected in the communication band (step ST1407). More specifically, sub-band selection section 114 selects K sub-band of band 2 or band 3 for which MCS having the highest transmission efficiency is selected from remaining band 2 and band 3 selected in the communication band. In the case of FIG. 13, because MCS with the same transmission efficiency is selected for band 2 and band 3, either one can be selected. Sub-band selection section 114 selects remaining band 3 or band 2 after removing selected band 2 or band 3 from the sub-bands to be selected (step ST1408) and repeats the processing from step ST1407 to step ST1410 until a predetermined count is reached in step ST1409 or a peak equal to or higher than threshold α is detected in step ST1410.

When a peak is detected by peak decision section 111 in step ST1410, sub-band selection section 114 returns the K sub-bands removed immediately before, as sub-bands to be selected again (step ST1411). More specifically, in FIG. 14, when only band 3 is selected and when band 2 is excluded from the selection target immediately before, sub-band selection section 114 returns band 2 as a band to be selected and selects band 2 and band 3.

Next, FFT section 116 performs FFT on the inverse replica generated by inverse replica generation section 112 (step ST1412).

Next, combination section 103 combines the transmission signal and the inverse replica subjected to FFT (step ST1413).

When there is a peak equal to or higher than threshold α in step ST1406, FFT section 116 performs FFT on the inverse replica (step ST1412) and combines the inverse replica and the transmission signal (step ST1413).

On the other hand, when the total count reaches a predetermined count in step ST1409, sub-band selection section 114 decides that there is no peak equal to or higher than the threshold and concludes the processing without performing peak suppression processing.

Furthermore, when there is no peak higher than threshold α in step ST1403, sub-band selection section 114 decides that there is no peak higher than the threshold and concludes processing without performing peak suppression processing.

In this way, in addition to the effect of above Embodiment 1, when no peak is detected after peak suppression and excessive peak suppression is performed, this embodiment 3 gradually reduces the number of sub-bands to be selected until a peak is detected and combines an inverse replica and a transmission signal when a peak is detected, so that deterioration of error rate characteristic due to excessive peak suppression can be prevented.

### Embodiment 4

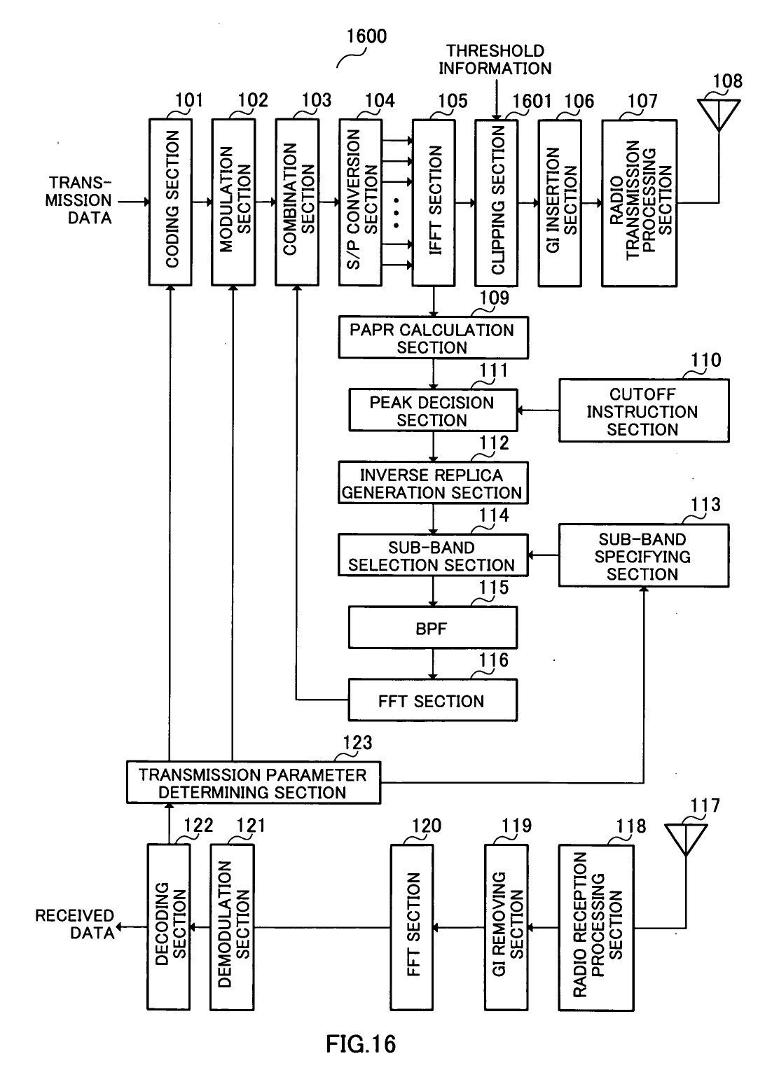

FIG.16 is a block diagram showing the configuration of radio communication apparatus 1600 according to Embodiment 4 of the present invention.

As shown in FIG. 16, radio communication apparatus 1600 according to this embodiment 4 adds clipping section 1601 to radio communication apparatus 100 according to Embodiment 1 shown in FIG. 1. In FIG. 16, the same components as those in FIG. 1 are assigned the same reference numerals and explanations thereof will be omitted.

Clipping section 1601 performs clipping processing on transmission data input from IFFT section 105 and outputs the result to GI insertion section 106. Clipping section 1601 compares a preset threshold with the signal level of the transmission data, and suppresses the signal level to the threshold when the signal level is equal to or higher than the threshold, and outputs the result to GI insertion section 106. When the signal level is lower than the threshold, transmission data is output as is to GI insertion section 106.

In this way, in addition to the effect of above Embodiment 1, this embodiment 4 combines an inverse replica and transmission data and then performs clipping processing, thereby reliably suppressing peaks.

### Embodiment 5

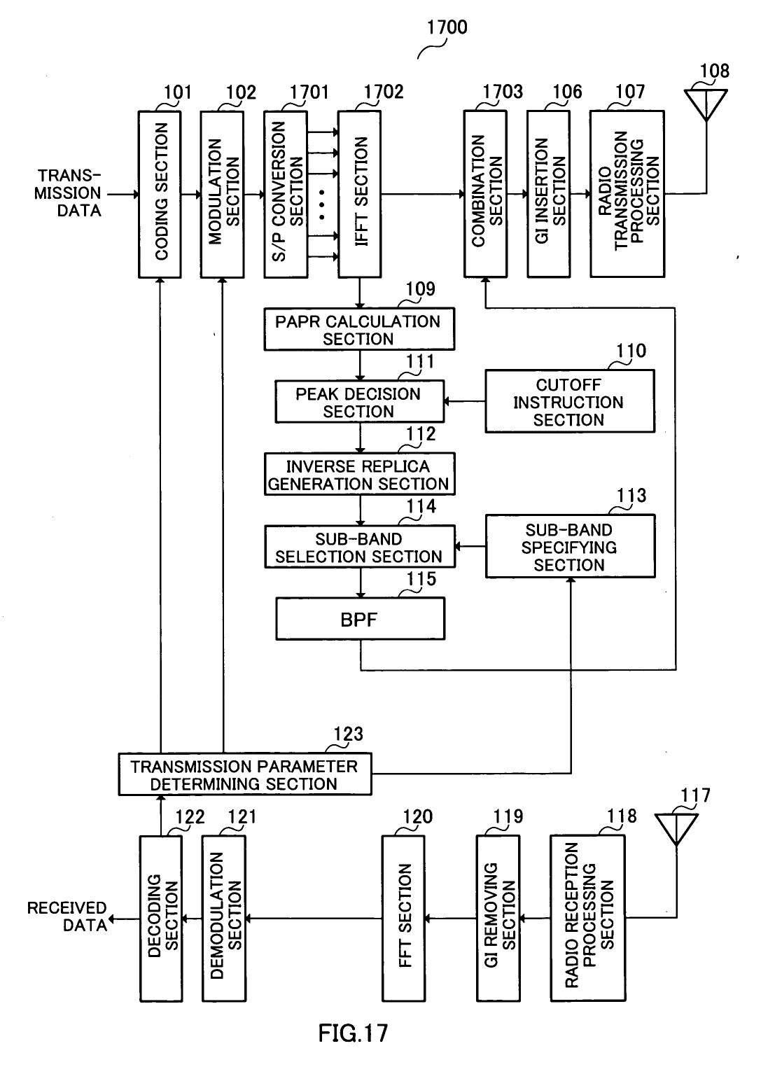

FIG. 17 is a block diagram showing the configuration of radio communication apparatus 1700 according to Embodiment 5 of the present invention.

As shown in FIG. 17, radio communication apparatus 1700 according to this embodiment 5 removes FFT section 116 from radio communication apparatus 100 according to of Embodiment 1 shown in FIG. 1 and has S/P conversion section 1701, IFFT section 1702 and combination section 1703 instead of combination section 103, S/P conversion section 104 and IFFT section 105. The same components in FIG. 17 as those in FIG. 1 are assigned the same reference numerals and explanations thereof will be omitted.

S/P conversion section 1701 converts transmission data input from modulation section 102 from a serial data format to a parallel data format and outputs the parallel data to IFFT section 1702.

IFFT section 1702 performs IFFT on the transmission data input from S/P conversion section 1701 and outputs the result to combination section 1703.

Combination section 1703 combines the waveform of the transmission data input from IFFT section 1702 and an inverse replica on the time axis based on inverse replica information input from BPF 115 and outputs the combined signal to GI insertion section 106.

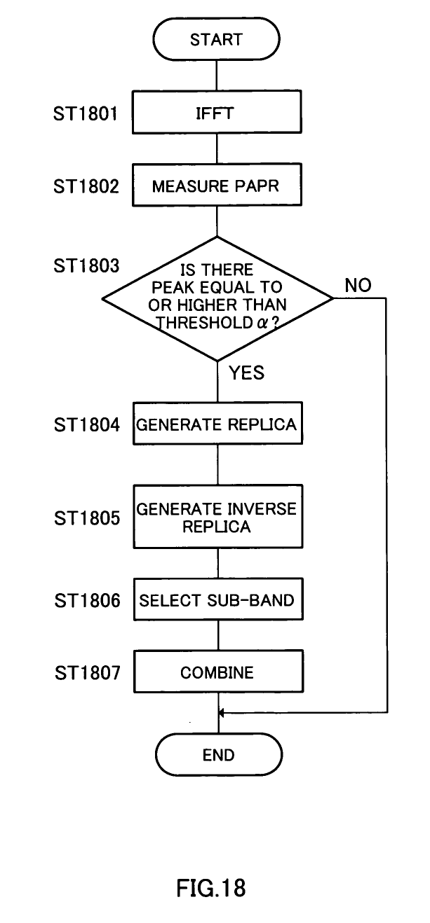

Next, peak suppression operation by radio communication apparatus 1700 will be explained using FIG. 18. FIG. 18 is a flow chart showing peak suppression operation of radio communication apparatus 1700 when suppressing peaks.

First, IFFT section 1702 performs IFFT on transmission data (step ST1801).

Next, PAPR calculation section 109 measures PAPR (step ST1802).

Next, as shown in FIG. 4, peak decision section 111 decides whether or not there is a peak whose PAPR is equal to or higher than threshold (α) from threshold information input from cutoff instruction section 110 (step ST1803).

When there is a peak whose PAPR is equal to or higher than threshold α, as shown in FIG. 5, inverse replica generation section 112 extracts waveform information whose amplitude is equal to or higher than threshold (β) and whose amplitude is equal to or lower than threshold (−β) in the relationship between time and amplitude of the transmission signal and generates a replica as shown in FIG. 6 (step ST1804).

Next, inverse replica generation section 112 generates an inverse replica which has the inverse characteristic of the generated replica as shown in FIG. 7 (step ST1805).

Next, sub-band selection section 114 selects the sub-band specified by sub-band specifying section 113 (step ST1806) and BPF 115 outputs the inverse replica in which unnecessary radiation components outside the frequency band of the sub-band specified by sub-band specifying section 113 removed. More specifically, as shown in FIG. 8, when MCS6 is selected for the transmission data assigned to subcarriers of band 1 and the transmission data is modulated by 16 QAM and when MCS3 is selected for the transmission data assigned to subcarriers of band 2 and the transmission data is modulated by QPSK, sub-band selection section 114 selects band 2 for which MCS having lower transmission efficiency is selected.

Next, combination section 1703 combines the transmission signal and the inverse replica subjected to IFFT (step ST1807).

In this way, according to this embodiment 5, in addition to the effect of above Embodiment 1, it is not necessary to repeat IFFT processing on the whole transmission data, thereby simplifying peak suppression processing.

The radio communication apparatus of above Embodiment 1 to Embodiment 5 can be applied to a base station apparatus and a communication terminal apparatus.

Each function block employed in the description of each of the aforementioned embodiments may typically be implemented as an LSI constituted by an integrated circuit. These may be individual chips or partially or totally contained on a single chip.

“LSI” is adopted here but this may also be referred to as “IC”, “system LSI”, “super LSI”, or “ultra LSI” depending on differing extents of integration.

Further, the method of circuit integration is not limited to LSI's, and implementation using dedicated circuitry or general purpose processors is also possible.

Further, if integrated circuit technology comes out to replace LSI's as a result of the advancement of semiconductor technology or a derivative other technology, it is naturally also possible to carry out function block integration using this technology. Application in biotechnology is also possible.

The present application is based on Japanese Patent Application No. 2003-341654, filed on Sep. 30, 2003, the entire content of which is expressly incorporated by reference herein.

Industrial Applicability

The transmission apparatus and peak suppression method according to the present invention suppresses peaks using some frequencies in a communication band, thereby providing the effect of preventing deterioration of overall error rate characteristics of transmission data, and is useful in peak suppression.

1. A transmission apparatus that transmits a frequency division multiplexed transmission signal based on reception quality information indicating reception quality of a communicating party, the transmission apparatus comprising:
a determining section that determines a modulation and coding scheme parameter per frequency;
a detection section that detects a peak of a transmission signal;
a generation section that generates a waveform with an inverse characteristic of a waveform of the peak;
a combination section that combines the waveform of the transmission signal and the waveform with the inverse characteristic at a frequency corresponding to a modulation and coding scheme parameter of a lowest transmission efficiency among modulation and coding scheme parameters determined for respective frequencies; and
a transmission section that transmits the transmission signal combined with the waveform with the inverse characteristic.

2. The transmission apparatus according to claim 1,
further comprising a selection section that selects frequencies in ascending order of transmission efficiency of the modulation and coding scheme parameters every time the peak is detected,
wherein the combination section combines the waveform of the transmission signal and the waveform with the inverse characteristic at selected frequencies.

3. The transmission apparatus according to claim 1, wherein the detection section detects the peak in the transmission signal combined with the waveform with the inverse characteristic,
further comprising a selection section that, when no peak is detected in the transmission signal combined with the waveform with the inverse characteristic, selects remaining frequencies after frequencies are removed from the frequencies in a communication band in descending order of transmission efficiency of corresponding modulation and coding scheme parameters, and
wherein the combination section combines the waveform of the transmission signal and the waveform with the inverse characteristic at the remaining frequencies.

4. The transmission apparatus according to claim 3, wherein the selection section repeats the processing of removing frequencies from the frequencies in the communication band in descending order of transmission efficiency of corresponding modulation and coding scheme parameters a predetermined number of times at a maximum.

5. The transmission apparatus according to claim 1, wherein the combination section combines the waveform of the transmission signal and the waveform with the inverse characteristic on a frequency axis.

6. The transmission apparatus according to claim 1, further comprising an inverse orthogonal transform section that performs an inverse orthogonal transform on the transmission signal,
wherein the combination section combines the transmission signal subjected to the inverse orthogonal transform and the waveform with the inverse characteristic.

7. A peak suppression method for suppressing a peak in a frequency division multiplexed transmission signal based on reception quality information indicating reception quality of a communicating party, the method comprising the steps of:
determining a modulation and coding scheme parameter per frequency;
detecting a peak of a transmission signal;
generating a waveform with an inverse characteristic of a waveform of the peak; and
combining the waveform of the transmission signal and the waveform with the inverse characteristic at a frequency corresponding to the modulation and coding scheme parameter of a lowest transmission efficiency among the modulation and coding scheme parameters determined for respective frequencies.
